(19) United States
(12) Patent Application Publication
(10) Pub. No.: US 2016/0092728 A1
(43) Pub. Date: Mar. 31, 2016

(54) ELECTRONIC DEVICE AND METHOD FOR PROCESSING HANDWRITTEN DOCUMENTS

(71) Applicant: Kabushiki Kaisha Toshiba, Tokyo (JP)

(72) Inventor: Hideki Tsutsui, Kawasaki Kanagawa (JP)

(21) Appl. No.: 14/663,873

(22) Filed: Mar. 20, 2015

(30) Foreign Application Priority Data
Sep. 30, 2014 (JP) 2014-200230

(51) Int. Cl. G06K 9/00; G06F 3/041; G06F 3/0354; G06F 17/24

(52) U.S. Cl. CPC G06K 9/00449; G06F 17/245; G06F 3/0412; G06F 3/03545; G06K 9/00402; G06F 2203/04106; G06K 2209/01

(57) ABSTRACT

According to one embodiment, an electronic device executes a process for outputting a recognition result of a handwritten table including regions defined by a set of strokes. When a first region of the regions spans columns or rows, and the first region corresponds to a rectangular shape, the recognition result of the handwritten table includes a first table object. The first table object includes a first merged cell corresponding to the first region. When the first region spans columns or rows, and the first region corresponds to a non-rectangular shape, the recognition result of the handwritten table includes a second table object. The second table object includes a second merged cell corresponding to a part of the first region.

### CROSS-REFERENCE TO RELATED APPLICATIONS

This application is based upon and claims the benefit of priority from Japanese Patent Application No. 2014-200230, filed Sep. 30, 2014, the entire contents of which are incorporated herein by reference.

### FIELD

Embodiments described herein relate generally to a technique for handwriting.

### BACKGROUND

Recently, various types of electronic devices, such as tablets, PDAs and smartphones, have been developed. Most of these electronic devices comprise a touch screen display for facilitating an input operation by a user.

A table recognizing technique of recognizing a table in a document image has also been developed recently.

However, little consideration has been given so far to a technique of facilitating the use of a recognition result of a handwritten table.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic device according to an embodiment.

FIG. 2 is an exemplary view showing the cooperation between the electronic device shown in FIG. 1 and an external device.

FIG. 3 shows a handwritten document example handwritten on the touch screen display of the electronic device shown in FIG. 1.

FIG. 4 is an exemplary view for explaining time-series data corresponding to the handwritten document of FIG. 3.

FIG. 5 is an exemplary block diagram showing the configuration of the electronic device shown in FIG. 1.

FIG. 6 is an exemplary block diagram showing the functionality configuration of a handwriting note application program executed by the electronic device of FIG. 1.

FIG. 7 shows an example of a handwritten table comprising a rectangular region that spans a plurality of columns and/or a plurality of rows.

FIG. 8 shows an example of a digital table object corresponding to the handwritten table of FIG. 7.

FIG. 9 an example of a handwritten table comprising a non-rectangular (L-shaped) region that spans a plurality of columns and/or a plurality of rows.

FIG. 10 shows an example of a digital table object including an L-shaped region.

FIG. 11 shows an example of a digital table object including two rectangular cells that provide an L-shaped region.

FIG. 12 shows another example of a digital table object including two rectangular cells that provide an L-shaped region.

FIG. 13 is a view for explaining a method example for dividing an L-shaped region in consideration of the positions of strokes (intra-cell strokes) in a handwritten table.

FIG. 14 is a view for explaining another method example for dividing an L-shaped region in consideration of the positions of strokes (intra-cell strokes) in a handwritten table.

FIG. 15 is a flowchart showing a procedure of handwritten table/digital table object conversion processing executed by the electronic device of FIG. 1.

FIG. 16 is a flowchart showing a procedure of merged cell dividing processing executed within handwritten table/digital table object conversion processing.

FIG. 17 shows an example of a position within an L-shaped region, in which a work cell should be set.

FIG. 18 shows an example of another position within an L-shaped region, in which the work cell should be set.

FIG. 19 is a view for explaining processing of extending the range of a work cell.

FIG. 20 is a view for explaining processing of dividing an L-shaped region by causing cells belonging to a work cell to be a merged cell.

FIG. 21 is a view showing an example of a digital table object including an L-shaped region.

FIG. 22 is a view showing an example of a digital table object including a plurality of rectangular merged cells providing an L-shaped region.

### DETAILED DESCRIPTION

Various embodiments will be described hereinafter with reference to the accompanying drawings.

In general, according to one embodiment, an electronic device comprises a display controller and processing circuitry. The display controller displays on a screen a handwritten document comprising a handwritten table, the handwritten table comprising a plurality of regions defined by a set of strokes corresponding to horizontal and vertical ruled lines. The processing circuitry executes a process for outputting a recognition result of the handwritten table. When a first region of the plurality of regions spans columns or rows, and the first region corresponds to a rectangular shape, the recognition result of the handwritten table comprises a first table object. The first table object comprises a first merged cell corresponding to the first region of the plurality of regions and a plurality of cells corresponding to other regions of the plurality of regions. When the first region of the plurality of regions spans columns or rows, and the first region corresponds to a non-rectangular shape, the recognition result of the handwritten table comprises a second table object. The second table object comprises a second merged cell corresponding to a part of the first region of the plurality of regions and the plurality of cells corresponding to other regions of the plurality of regions, the second merged cell having a rectangular shape.

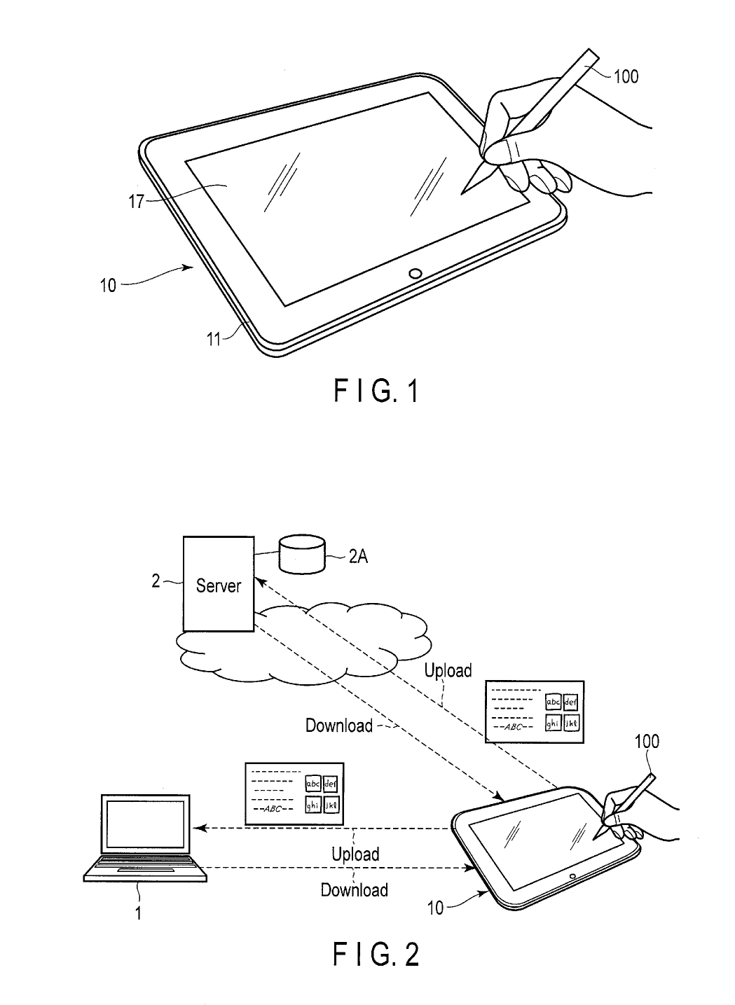

FIG. 1 is an exemplary perspective view showing the appearance of an electronic device according to an embodiment. This electronic device is a pen-based portable electronic device that permits a pen (stylus) or a finger to input handwritten data. The electronic device can be realized as a tablet computer, a notebook PC, a smartphone, a PDA, etc. In the description below, it is assumed that the electronic device is realized as a tablet computer 10. The tablet computer 10 comprises a main unit 11 and a touch screen display 17 as shown in FIG. 1. The main unit 11 has a thin box-shaped housing. The touch screen display 17 is attached to the main unit 11, superposed on the upper surface thereof.

The touch screen display 17 incorporates a flat panel display and a sensor. The sensor detects the contact position of a pen or a finger on the screen of the flat panel display. The flat panel display may be a liquid crystal display (LCD) device. The sensor may be an electrostatic capacitance type touch panel or an electromagnetic induction type digitizer. In the description below, it is assumed that the touch screen display 17 incorporates two types of sensors, i.e., the digitizer and the touch panel, although it does not have to incorporate both of them.

The digitizer is provided below the flat panel display screen. The touch panel is provided on, for example, the screen of the flat panel display. The touch screen display 17 can detect not only a touch operation on the screen using a finger, but also a touch operation on the screen using a pen 100. The pen 100 is, for example, a digitizer pen (electromagnetic induction pen), an active pen and a passive pen.

The user can perform a handwriting input operation on the touch screen display 17, using an external object (pen 100 or finger). During a handwriting input operation, the locus of the movement of the external object (pen 100 or finger) on the screen, i.e., a stroke (strokes), is rendered in real time. The locus of the movement of the external object during the time when the external object is kept in contact with the screen corresponds to one stroke. A set of a large number of strokes corresponding to handwritten characters, tables and/or figures constitutes a handwritten document.

In the embodiment, the handwritten document is stored in a storage medium not in the form of image data but in the form of time-series data that is indicative of a series of coordinates of the locus of each stroke and indicative of the order relation of strokes. The time-series data includes a plurality of stroke data items corresponding to respective strokes. Each stroke data item corresponds to one stroke, and includes coordinate data series (time-series coordinates) corresponding to respective points of the one stroke. The order of arrangement of the stroke data items corresponds to the order of handwriting of the strokes.

The tablet computer 10 can read arbitrary existing time-series data from the storage medium, and display, on the screen, a handwritten document corresponding to the time-series data, i.e., a plurality of strokes indicated by the time-series data. Further, the tablet computer 10 has an editing function. The editing function enables an arbitrary stroke, an arbitrary handwritten character, etc., in the displayed handwritten document to be copied, cut and moved, by means of an “erasure” tool, a “selection (range selection)” tool, and other various tools. The editing function includes a function of cancelling some handwriting operations (UNDO) and a function of re-executing some cancelled handwriting operations (REDO).

The tablet computer 10 also has a recognition function of recognizing a handwritten document. The recognition function includes a character recognition function, a table recognition function and a figure recognition function. These recognition functions enable a handwritten object (a handwritten character, a handwritten table, a handwritten figure) to be converted into a digital object (digital graphical object). The digital object may be output as formatted digital data. The formatted digital data is a data file having a file format that can be processed by another application program, such as an office application.

FIG. 2 shows the cooperation between the tablet computer 10 and an external device. The tablet computer 10 can cooperate with the personal computer 1 or a cloud. Namely, the tablet computer 10 comprises a wireless communication device, such as a wireless LAN, and can communicate with the personal computer 1 by radio. The tablet computer 10 can also communicate with a server 2 on the Internet. The server 2 may be a server that provides online storage service and other various types of cloud computing service.

The personal computer 1 comprises a storage device, such as a hard disk drive (HDD). The tablet computer 10 can transmit time-series data (handwritten document) to the personal computer 1 via a network, and store it in the HDD of the personal computer 1 (upload).

Further, the tablet computer 10 can read one or more arbitrary handwritten documents from the HDD of the personal computer 1 (download). The tablet computer 10 can display, on the screen of the touch screen display 17, strokes corresponding to the read handwritten document.

Further, as mentioned above, the tablet computer 10 may communicate with the server 2 on the cloud, which provides, for example, storage service, instead of the personal computer 1. The tablet computer 10 can transmit a handwritten document to the server 2 via a network, and store it in a storage device 2A incorporated in the server 2 (upload). Further, the tablet computer 10 can read an arbitrary handwritten document from the storage device 2A of the server 2 (download). The tablet computer 10 can display, on the screen of the touch screen display 17, strokes corresponding to the read handwritten document.

As described above, in the embodiment, the storage medium for storing handwritten documents may be any one of the storage devices in the tablet computer 10, the personal computer 1 and the server 2.

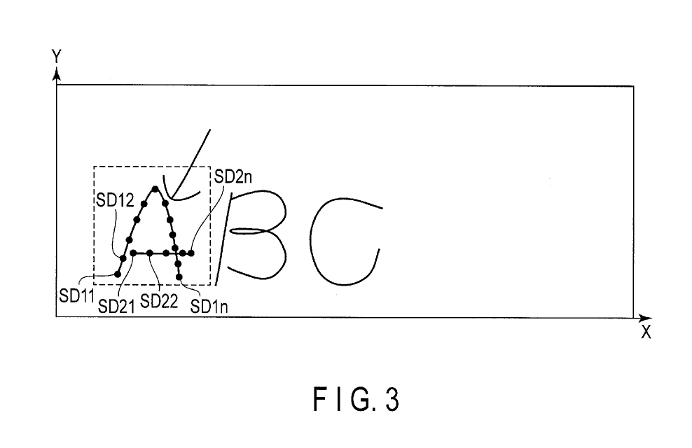

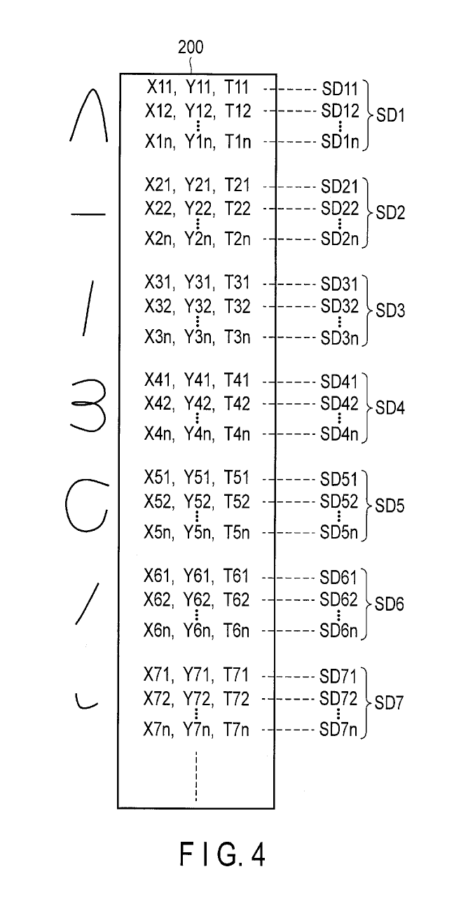

Referring then to FIGS. 3 and 4, a description will be given of the relationship between a stroke handwritten by the user and a handwritten document. FIG. 3 shows an example of a character string handwritten on the touch screen display 17 using, for example, the pen 100.

In a handwritten document, a character or figure may often be handwritten on an already handwritten character or figure. In the case of FIG. 3, it is assumed that a character string “ABC” is handwritten in the order of “A,” “B” and “C,” and thereafter an arrow is handwritten close to the handwritten channel “A.”

The handwritten character “A” is expressed by two strokes (i.e., a stroke in the form of “̂” and a stroke in the form of “-”) handwritten using, for example, the pen 100. The first handwritten stroke “̂” is sampled in real time at, for example, regular intervals, whereby time-series coordinates SD11, SD12, . . . , SD1n corresponding to the stroke “̂” are obtained. Similarly, the subsequent handwritten stroke “-” is sampled in real time at regular intervals, whereby time-series coordinates SD21, SD22, . . . , SD2n corresponding to the stroke “-” are obtained.

The handwritten character “B” is expressed by two strokes handwritten using, for example, the pen 100. The handwritten character “C” is expressed by one stroke handwritten using, for example, the pen 100. The handwritten “arrow” is expressed by two strokes handwritten using, for example, the pen 100.

FIG. 4 shows time-series data 200 corresponding to the handwritten character string of FIG. 3. The time-series data 200 includes a plurality of stroke data items SD1, SD2, . . . , SD7. In the time-series data 200, stroke data items SD1, SD2, . . . , SD7 are arranged in the order of handwriting, i.e., in the time-series order in which the strokes were handwritten.

In the time-series data 200, two lead stroke data items SD1 and SD2 are indicative of the two strokes of the handwritten character “A.” Third and fourth stroke data items SD3 and SD4 are indicative of the two strokes of the handwritten character “B.” Fifth stroke data item SD5 is indicative of the one stroke of the handwritten character “C.” Sixth and seventh stroke data items SD6 and SD7 are indicative of the two strokes of the handwritten “arrow.”

Each stroke data item includes pairs of coordinates corresponding to a plurality of points of one stroke. In each stroke data item, pairs of coordinates are arranged in the order in which the points of a corresponding stroke were handwritten. For instance, regarding the handwritten character “A,” stroke data SD1 includes a coordinate data sequence (time-series coordinates) corresponding to points on the stroke “̂” in the handwritten character “A,” i.e., n coordinate data items SD11, SD12, . . . , SD1n. Similarly, stroke data SD2 includes a coordinate data sequence corresponding to points on the stroke “-” in the handwritten character “A,” i.e., n coordinate data items SD21, SD22, . . . , SD2n. The stroke data items may include different numbers of coordinate data items.

Each coordinate data item comprises an X coordinate and a Y coordinate indicative of a corresponding point on a stroke. For instance, coordinate data item SD11 comprises the X coordinate (X11) and the Y coordinate (Y11) of the start point of the stroke “̂.” Coordinate data item SD1n comprises the X coordinate (X1n) and the Y coordinate (Y1n1) of the end point of the stroke “̂.”

Further, a respective coordinate data item may include timestamp data T corresponding to a time at which a point indicated by the coordinate data item was handwritten. The point-handwritten time may be an absolute time (e.g., year, month, day, hour, second) or a relative time with respect to a certain reference time. For instance, an absolute time (e.g., year, month, day, hour, second) when writing of a stroke has been started may be added to a respective stroke data item as timestamp data, and further a relative time indicative of a difference from the absolute time may be added to the respective stroke data item as timestamp data T.

In addition, data (Z) indicative of writing pressure may be added to each coordinate data item.

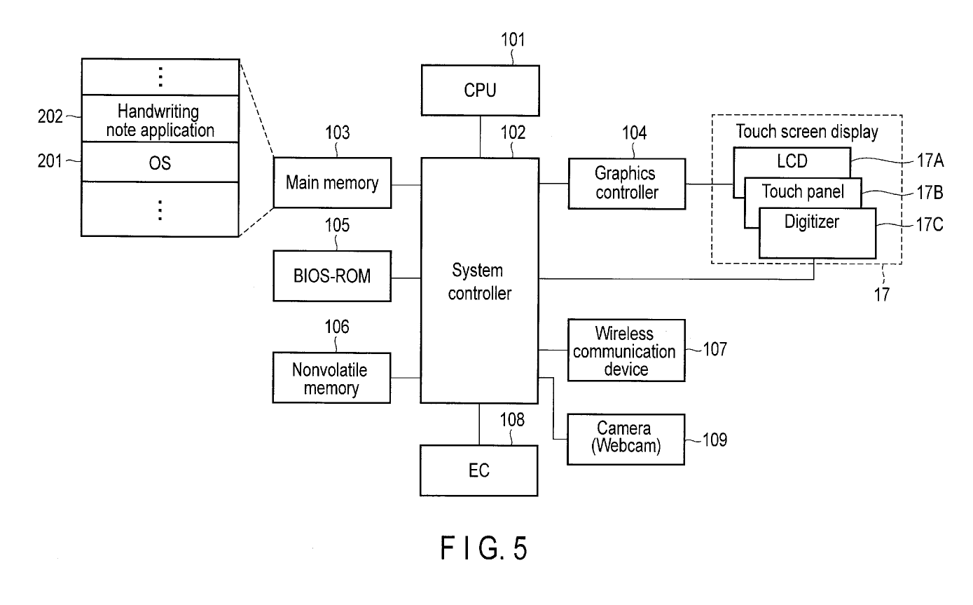

FIG. 5 shows a configuration example of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, a camera (Web cam) 109, etc.

The CPU 101 is a processor configured to control the operations of various components in the tablet computer 10. The processor includes processing circuitry. The CPU 101 executes various types of software loaded from the nonvolatile memory 106 onto the main memory 103. The software includes an operating system (OS) 201 and various application programs. The application programs include a handwriting note application program 202. The handwriting note application program 202 is a digital notebook application that enables a memo to be made. The handwriting note application program 202 has a function of creating and displaying handwritten documents, editing handwritten documents, recognizing handwritten documents, etc.

The CPU 101 also executes a basic input output system (BIOS) stored in the BIOS-ROM 105. The BIOS is a program for hardware control.

The system controller 102 is a device configured to connect a local bus of the CPU 101 and various other components. The system controller 102 contains a memory controller for performing access control of the main memory 103. The system controller 102 also has a function of communicating with the graphics controller 104 via a serial bus of the PCI EXPRESS standard.

The graphics controller 104 is a display controller configured to control an LCD 17A used as the display monitor of the tablet computer 10. The graphics controller 104 includes display control circuitry. When the handwriting note application program 202 has been executed, the graphics controller 104 can display a handwritten document including a plurality of strokes on the screen of the LCD 17A under the control of the handwriting note application program 202. The handwritten document may comprises a handwritten table, the handwritten table comprising a plurality of regions defined by a set of strokes corresponding to horizontal and vertical ruled lines. The display signals generated by the graphics controller 104 are sent to the LCD 17A. The LCD 17A displays screen images based on the display signals. On the LCD 17A, a touch panel 17B is provided. Under the LCD 17A, a digitizer 17C is provided. The graphics controller 104 may be included in the CPU 101.

The wireless communication device 107 is configured to execute wireless communication, such as a wireless LAN or 3G mobile communication. The wireless communication device 107 includes a transmitter configured to transmit signals and a receiver configured to receive signals.

The EC 108 is a one-chip microcomputer including an embedded controller for power management. The EC 108 has a function of turning on and off the tablet computer 10 in accordance with a user's operation of a power button.

The camera (Web cam) 109 is a capture device for capturing an image (a still image, a moving image) of an arbitrary object. The tablet computer 10 may incorporate a peripheral interface for communicating with another input device (a mouse, a keyboard, etc.).

A description will now be given of some features of the handwriting note application program 202.

The handwriting note application program 202 can render strokes by the pen 100. The handwriting note application program 202 can render strokes by touch (finger gesture) or mouse in a touch input mode. The touch input mode is a mode for rendering strokes using a finger or the mouse. The user can turn on and off the touch input mode.

A page-input/editing function will be described.

The handwriting note application program 202 can select an arbitrary handwritten object (one or more strokes) within a page, or the entire page, using a “selection (range selection)” tool.

The handwriting note application program 202 supports copy/cut/paste functions. The clipboard function of the OS may be utilized as copy/cut/paste functions. The clipboard is a temporary storage area for exchanging data between application programs. The handwriting note application program 202 can perform the following four types of copies:

“Copy”: The handwriting note application program 202 copies (stores) a selected handwritten object as stroke data on the clipboard. The stroke data includes coordinates of a plurality of points corresponding to each stroke. The paste target application is the handwriting note application program 202.

“Copy as an image”: The handwriting note application program 202 copies (stores) a selected handwritten object as an image (image data) on the clipboard. The image is, for example, a bit map. The handwriting note application program 202 converts the selected handwritten object into image data, and copies (stores) the image data on the clipboard. The paste target application is an application for processing images.

“Copy as office data”: The handwriting note application program 202 copies (stores) the selected handwritten object (a handwritten character string, a handwritten table, a handwritten figure, etc.) as a digital object on the clipboard. This digital object may be a formatted digital object, i.e., a data file having a file format that can be processed by another application program. The handwriting note application program 202 converts the selected handwritten object into a digital object, and copies (stores) the digital object as a formatted digital object on the clipboard. The paste target application is, for example, a presentation application, a word processing application, a spread sheet application, etc.

Processing of converting the selected handwritten object into the digital object is executed utilizing functions of character recognition, figure recognition and table recognition. The function of character recognition converts a set of strokes corresponding to a handwritten character string into recognized text (character code). The function of figure recognition converts a set of strokes corresponding to a handwritten figure into a figure object (digital figure object). The function of table recognition converts a set of strokes corresponding to a handwritten table into a table object (digital table object).

The handwriting note application program 202 also supports import/export functions. The handwriting note application program 202 can output (export) a digital object corresponding to a selected handwritten object (a handwritten character string, a handwritten table, a handwritten figure, etc.) to another application program. As in the case of “copy as office data,” processing of converting the selected handwritten object into the digital object is executed utilizing the functions of character recognition, figure recognition and table recognition.

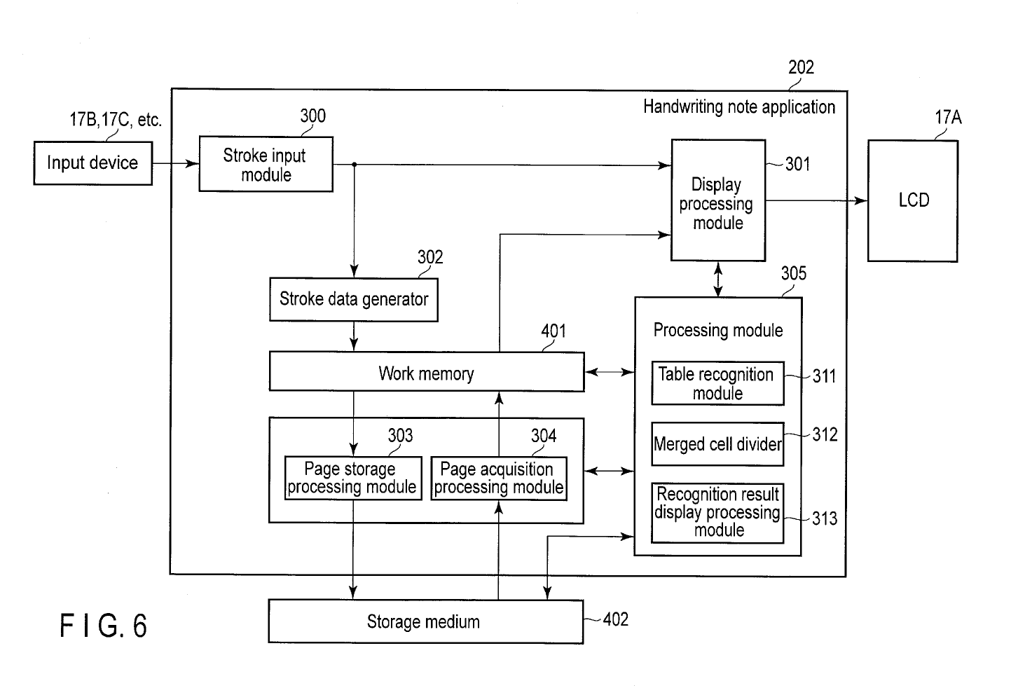

Referring then to FIG. 6, the functionality configuration of the handwriting note application program 202 will be described.

The handwriting note application program 202 comprises functionality execution modules for processing handwritten documents, such as a stroke input module 300, a display processing module 301, a stroke data generator 302, a page storage processing module 303, a page acquisition processing module 304 and a processing module 305.

The handwriting note application program 202 uses stroke data input via the touch screen display 17, thereby generating, displaying, editing, etc., handwritten page data. The touch screen display 17 (touch panel 17B, digitizer 17C) is configured to detect occurrence of events, such as “touch,” “slide” and “release.” “Touch” is an event indicating that a pen or finger has touched the screen. “Slide” is an event indicating that the contact position of the pen or finger on the screen has moved. “Release” is an event indicating that the pen or finger has been detached from the screen.

The stroke input module 300 receives the event “touch” or “slide” from the touch screen display 17, thereby detecting a handwriting input operation. The event “touch” includes the coordinates of a contact position. The event “slide” includes the coordinates of a contact position as a destination. Thus, the stroke input module 300 can receive, from the touch screen display 17, a coordinate sequence corresponding to strokes input by handwriting.

The display processing module 301 displays a handwritten page (handwritten document) including a plurality of strokes on the screen of the LCD 17A. The handwritten page may include a handwritten table. The handwritten table includes regions defined by a set of strokes corresponding to horizontal and vertical ruled lines. Namely, the display processing module 301 receives a coordinate sequence from the stroke input module 300, and displays each stroke input by handwriting on the screen of the LCD 17A, based on the coordinate sequence. Further, the display processing module 301 can display, on the screen of the LCD 17A, each stroke in a handwritten document read from a storage medium 402.

The stroke data generator 302 receives the above-mentioned coordinate sequence from the stroke input module 300, and generates time-series data having the structure described above in detail with reference to FIG. 4. The time-series data may be temporarily stored in the work memory 401.

The page storage processing module 303 stores time-series data (stroke data) in the storage medium 402. The page storage processing module 303 may store a currently edited handwritten page in the storage medium 402 periodically and automatically. When the handwriting note application program 202 is suspended or exited, the page storage processing module 303 may automatically store a currently edited handwritten page in the storage medium 402.

The page acquisition processing module 304 acquires, from the storage medium 402, a handwritten document to be viewed or edited.

The processing module 305 executes, on a handwritten page, various functions, such as character recognition, figure recognition and table recognition. The processing module 305 executes processing for outputting the recognition result of a handwritten table on a currently viewed/edited handwritten page. The handwritten table includes a plurality of regions defined by a set of strokes corresponding to vertical and horizontal ruled lines. The processing module 305 outputs, as the recognition result of the handwritten table, a table object including a plurality of cells corresponding to a plurality of regions in the handwritten table.

The processing module 305 can process a handwritten table that includes a region (a handwritten merged cell) that spans at least a plurality of columns or rows. This region may be rectangular or non-rectangular. The non-rectangular region is generally called “an L-shaped region” or “an L-shaped merged cell.”

A general spread sheet application does not support a non-rectangular merged cell (L-shaped merged cell). Further, the general spread sheet application does not have a user interface for creating the L-shaped merged cell. However, in the tablet computer 10, the user can freely render a table of an arbitrary structure by handwriting. Therefore, the handwritten table may include a non-rectangular region, such as an L-shaped region.

Regardless of whether a region (handwritten merged cell) included in a handwritten table as a processing target is rectangular or not rectangular, the processing module 305 can output, as the recognition result of the handwritten table, a table object (digital table object) that can be processed by the general spread sheet application. In other words, the processing module 305 can change the structure of the table object (digital table object) to be output as the recognition result of the handwritten table, depending upon whether the region (handwritten merged cell) included in the handwritten table as a processing target is rectangular or not rectangular.

When a region (handwritten merged cell, i.e., first region) of plural regions of the handwritten table spans columns or rows, and the first region corresponds to a rectangular shape, the recognition result of the handwritten table comprises a first digital table object. The first digital table object comprises a first merged cell corresponding to the first region of the plural regions and plural cells corresponding to other regions of the plural regions. When the first region of the plural regions spans columns or rows, and the first region corresponds to a non-rectangular shape, the recognition result of the handwritten table comprises a second digital table object. The second digital table object comprises a second merged cell corresponding to a part of the first region and the plural cells corresponding to other regions of the plural regions, the second merged cell having a rectangular shape.

Specially, if the shape of the region (handwritten merged cell) corresponds to a rectangular shape, a rectangular region within the digital table object corresponding to that region (handwritten merged cell) is formed of one rectangular merged cell. Namely, plural cells (i.e., a plurality of unit cells) within the rectangular region in the digital table object are combined into a single rectangular merged cell.

In contrast, if the shape of the region (handwritten merged cell) corresponds to a non-rectangular shape (e.g., an L-shape), a non-rectangular region within the digital table object corresponding to the region (handwritten merged cell) is formed of a combination of rectangular merged cells, or a combination of one or more rectangular merged cells and one or more unit cells. Namely, plural cells (i.e., a plurality of unit cells) in the non-rectangular region of the digital table object are combined to form some merged cells that each have a rectangular shape.

The processing module 305 comprises, for example, a table recognition module 311, a merged cell divider 312 and a recognition result display processing module 313.

The table recognition module 311 executes table recognition processing for recognizing a handwritten table in a handwritten page. By table recognition processing, a set of strokes corresponding to a handwritten table in the handwritten document are converted into a table object (digital table object) including a plurality of cells. The digital table object has the same number of regions (cells) as the handwritten table. Each cell in the digital table object is formed of a unit cell or a merged cell. The merged cell is a cell spanning at least a plurality of adjacent columns or rows.

Table recognition processing is executed as follows:

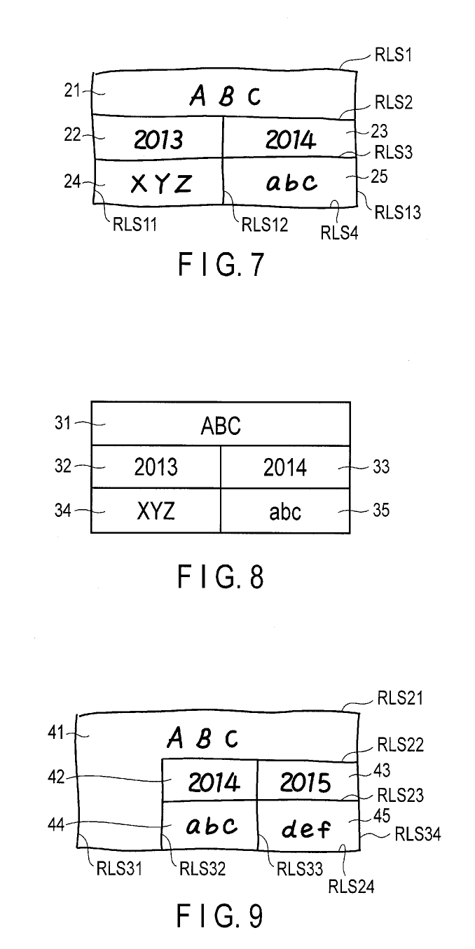

(1) The table recognition module 311 detects a set of strokes corresponding to horizontal and vertical ruled lines. In other words, the table recognition module 311 detects strokes that are substantially linear lines, and regards these strokes as ruled lines (ruled-line strokes). In this case, the table recognition module 311 may determine that a stroke, which has a length not less than a threshold and includes a segment regarded as a substantially horizontal or vertical line, is a ruled-line stroke. For instance, in the case of the handwritten table shown in FIG. 7, horizontally extending strokes RLS1, RLS2, RLS3 and RLS4 are detected in the handwritten page as strokes (horizontal ruled-line strokes) corresponding to four horizontal ruled lines. Further, vertically extending strokes RLS11, RLS12 and RLS13 are detected in the handwritten page as strokes (vertical ruled-line strokes) corresponding to three vertical ruled lines.

(2) The table recognition module 311 determines that a region in which vertical and horizontal ruled-line strokes intersect each other by a certain ratio or more is regarded as a handwritten table.

(3) The table recognition module 311 recognizes that the structure (the number of rows, the number of columns, regions (cells)) of the handwritten table, based on how the vertical and horizontal ruled-line strokes are connected to each other. For instance, in the handwritten table shown in FIG. 7, RLS11, RLS1, RLS13 and RLS4 are handled as the outer peripheral ruled lines of the handwritten table. Namely, this handwritten table is recognized to be a table with three rows and two columns. Further, since vertical ruled-line stroke RLS12 is shorter than the other vertical ruled-line strokes RLS11 and RLS13, and a region 21 is not partitioned by vertical ruled-line stroke RLS12, the region 21 is recognized to be a region (handwritten merged cell) spanning two columns.

(4) The table recognition module 311 converts the handwritten table into a digital table object that has the same number of regions (cells) as the handwritten table. A region (handwritten merged cell) spanning at least adjacent columns or rows within the handwritten table may be converted into a merged cell within the digital table object. Further, a region (cell) that does not span adjacent columns or rows within the handwritten table may be converted into a single unit cell within the digital table object.

For example, the handwritten table of FIG. 7 is converted into a digital table object shown in FIG. 8. The handwritten table of FIG. 7 includes a rectangular region (handwritten merged cell) 21 spanning two adjacent columns. The region 21 is converted into a rectangular region (merged cell) 31 in the digital table object of FIG. 8. The merged cell 31 is a rectangular merged cell obtained by combining two cells arranged horizontally.

The other regions (cells) 22, 23, 24 and 25 in the handwritten table of FIG. 7 are converted into cells 32, 33, 34 and 35 in the digital table object of FIG. 8, respectively. The cells 32, 33, 34 and 35 are each formed of a unit cell (single cell).

If the handwritten table includes a region that spans at least a plurality of columns or rows and whose shape corresponds to a rectangular shape, for example, if the handwritten table includes the region 21 of FIG. 7, the recognition result of the handwritten table is a digital table object in which a rectangular region corresponding to the above-mentioned region is formed of one merged cell (e.g., the merged cell 31 of FIG. 8).

Furthermore, strokes (intra-cell strokes) in each region of the handwritten table are converted into a character string (text) by character recognition. The resultant text is allocated to the respective cells in the digital table object.

FIG. 9 shows a handwritten table including an L-shaped region. The L-shaped region corresponds to a non-rectangular region spanning a plurality of columns and rows. This handwritten table includes five regions (cells) 41 to 45 defined by four horizontal ruled-line strokes RLS21 to RLS24 and four vertical ruled-line strokes RLS31 to RLS34. The region (cell) 41 is an L-shaped region.

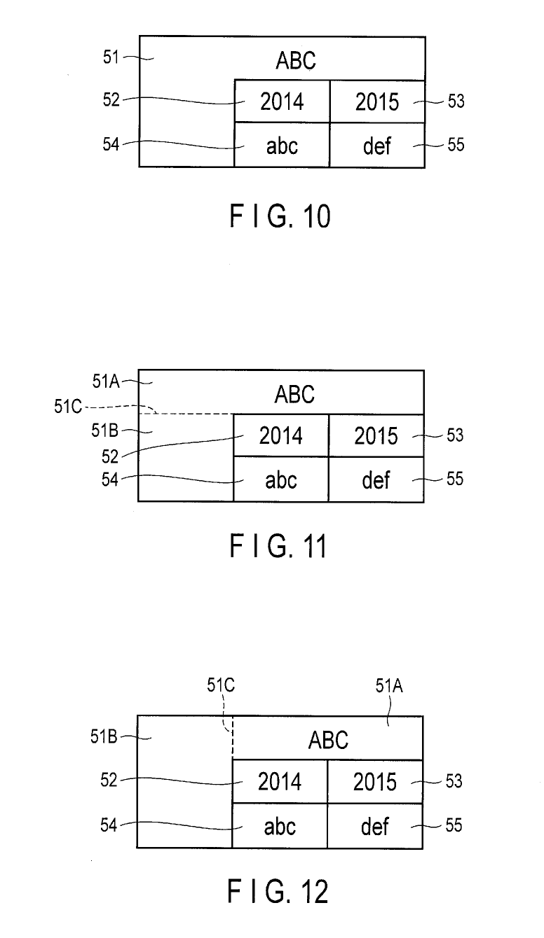

The handwritten table of FIG. 9 may be converted into a digital table object shown in FIG. 10. The handwritten table of FIG. 9 includes an L-shaped region 41 spanning three columns and three rows. The region 41 is converted into an L-shaped region (L-shaped merged cell) 51 in the digital table object of FIG. 10. The L-shaped merged cell 51 is a non-rectangular merged cell obtained by combining five cells in the L-shaped region. The other regions (cells) 42, 43, 44 and 45 in the handwritten table of FIG. 9 are converted into cells 52, 53, 54 and 55, respectively, in the digital table object of FIG. 10. The cells 52, 53, 54 and 55 are each formed of a single cell (i.e., a unit cell).

However, the digital table object of FIG. 10 cannot normally be displayed by a general spread sheet application. This is because the digital table object of FIG. 10 includes the L-shaped merged cell 51 that cannot be processed by the general spread sheet application.

To overcome the above, in the embodiment, the processing module 305 outputs a digital table object shown in FIG. 11 as a recognition result of the handwritten table of FIG. 9. In the digital table object of FIG. 11, a part of the L-shaped region 41 is converted to a merged cell having a rectangular shape.

For example, the L-shaped region 41 in the handwritten table is converted into two merged cells 51A and 51B in the digital table object. Merged cell 51A corresponds to a part of the L-shaped region 41, and merged cell 51B corresponds to the remaining part of the L-shaped region 41.

Merged cell 51A is a rectangular merged cell obtained by combining three cells arranged horizontally. Merged cell 51B is a rectangular merged cell obtained by combining two cells arranged vertically. The other regions (cells) 42, 43, 44 and 45 in the handwritten table of FIG. 9 are converted into cells 52, 53, 54 and 55, respectively, in the digital table object of FIG. 11. The cells 52, 53, 54 and 55 are each formed of a single cell.

As described above, the non-rectangular region of the digital table object corresponding to the L-shaped region 41 of the handwritten table is formed of a combination of two merged cells that are each rectangular.

The digital table object of FIG. 11 may be directly formed from the handwritten table of FIG. 9, or be formed by dividing the L-shaped merged cell 51 of FIG. 10.

In the latter case, the merged cell divider 312 divides the L-shaped merged cell 51 as a non-rectangular merged cell into a plurality of cells that are each rectangular. These cells (divided cells) may consist of only merged cells that are each rectangular. Alternatively, the cells (divided cells) may include at least one rectangular merged cell and one or more unit cells. Each of the unit cells is also rectangular.

For instance, the L-shaped merged cell (non-rectangular merged cell) 51 of FIG. 10 may be divided by the merged cell divider 312 into rectangular merged cell 51A spanning three columns, and rectangular merged cell 51B spanning two rows, as is shown in FIG. 11. As a result, all merged cells in the digital table object are rectangular merged cells. Thus, a digital table object that can be displayed and edited by the normal spread sheet application is obtained.

Further, the merged cell divider 312 may set a hidden ruled line in each boundary between divided cells. In this case, for example, hidden ruled line 51C is set between merged cells 51A and 51B as shown in FIG. 11. As the hidden ruled line, an arbitrary invisible ruled line can be used. For instance, the hidden ruled line may be transparent ruled lines or be colored in the same color as the background color of the divided cells. By setting hidden ruled lines in respective boundaries between the divided cells, the non-rectangular region (L-shaped merged cell) can be divided into a plurality of merged cells that are each rectangular, with its physical appearance kept in the non-rectangular shape.

The L-shaped merged cell 51 of FIG. 10 may be divided into rectangular merged cell 51A spanning two columns, and rectangular merged cell 51B spanning three rows, as is shown in FIG. 12.

As described above, if a handwritten table includes a region that spans at least a plurality of columns or rows and whose shape corresponds to a non-rectangular shape, for example, if the handwritten table includes the region 41 of FIG. 9, the recognition result of the handwritten table is a digital table object in which the non-rectangular region of the digital table object corresponding to the region 41 is formed of a combination of a plurality of merged cells (e.g., merged cells 51A and 51B in FIG. 11) that are each rectangular, or formed of a combination of one or more merged cells each having a rectangular shape and one or more unit cells that are each rectangular.

Further, strokes (intra-cell strokes) in each region of the handwritten table are converted into a character string (text) by character recognition. The text is allocated to respective cells in the digital table object. In the merged cell, the character string (text) is generally centered.

Methods of dividing the L-shaped region of the digital table object include a method of dividing the region so that the entire horizontal component of the region (spanning three columns) will become one merged cell, as is shown in FIG. 11, and a method of dividing the region so that the entire vertical component of the region (spanning three rows) will become one merged cell, as is shown in FIG. 12.

In accordance with the positions of the strokes (intra-cell strokes) in the handwritten table, which one of the methods should be employed may be determined.

In other words, in the embodiment, a set of cells, which are included in the cells of the L-shaped region of the digital table object and should be combined into one cell, may be determined in accordance with the positions of the intra-cell strokes in the L-shaped region of the handwritten table. That is, a set of cells to be combined into a merged cell (the above second merged cell) is determined in accordance with positions of one or more strokes written in the L-shaped region of the handwritten table.

Briefly, when strokes are written in the horizontal component of the L-shaped region, plural cells in the horizontal component are preferentially combined to form one merged cell. In contrast, when strokes are written in the vertical component of the L-shaped region, plural cells in the vertical component are preferentially combined to form one merged cell.

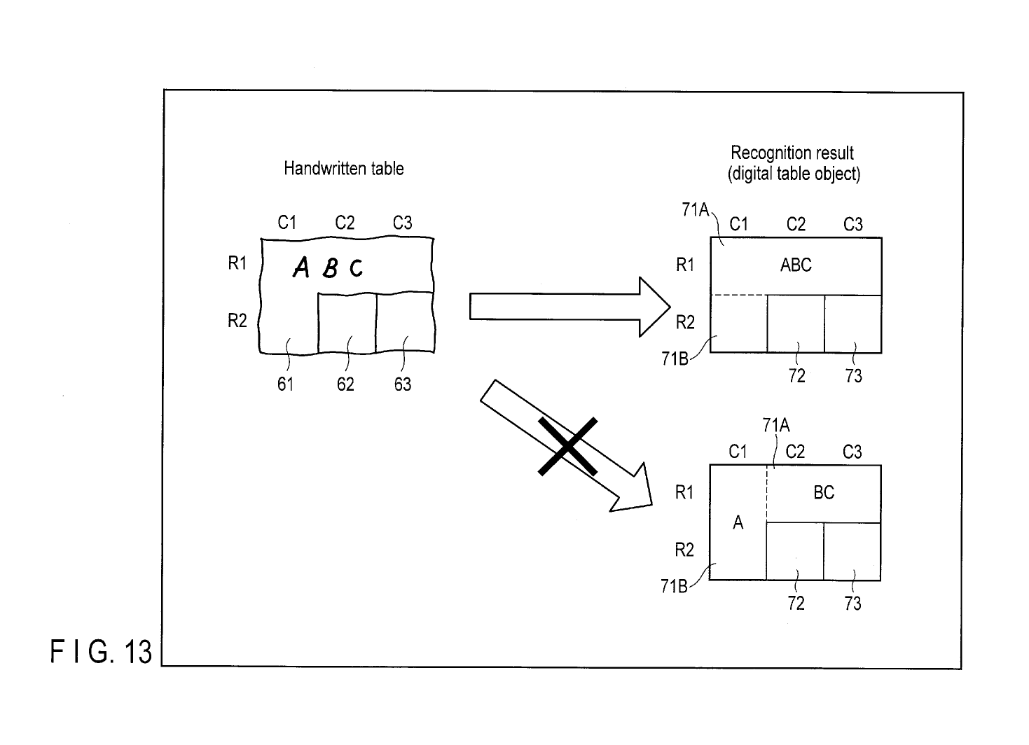

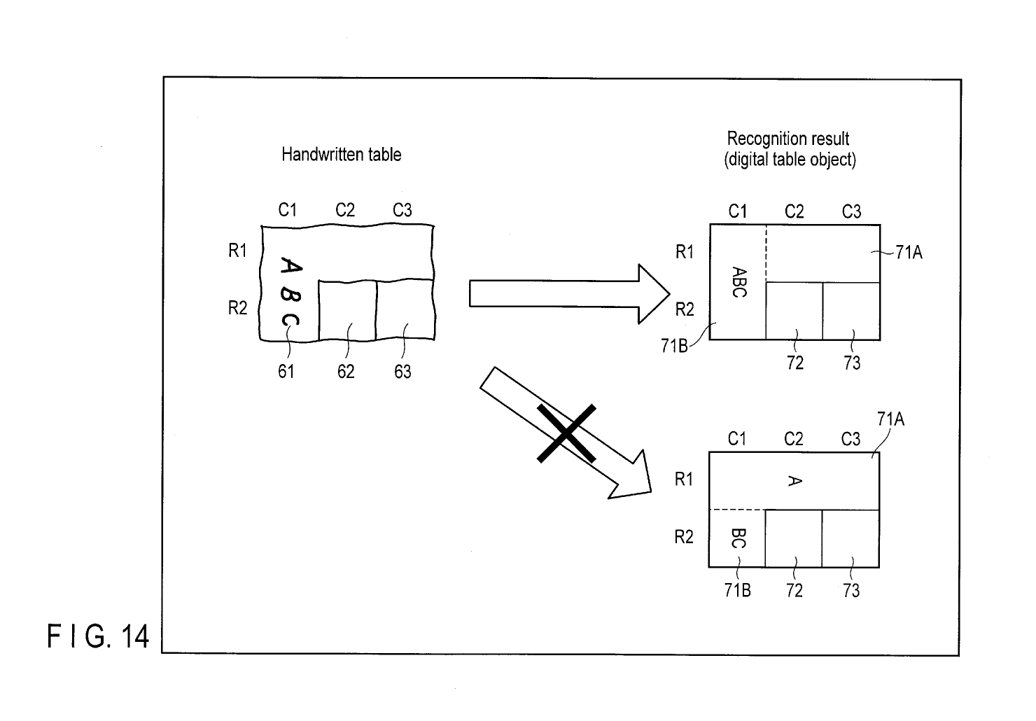

Referring now to FIGS. 13 and 14, a description will be given of an L-shaped region dividing method considering the positions of strokes (intra-cell strokes) in the handwritten table.

In FIGS. 13 and 14, reference symbols C1 to C3 representing columns and reference symbols R1 and R2 representing rows are used only for facilitating the description, and are not displayed actually.

In FIG. 13, the handwritten table includes a single L-shaped region (L-shaped merged cell) 61, and two rectangular regions (cells) 62 and 63. The L-shaped region (L-shaped merged cell) 61 includes a cell (R1, C1), a cell (R1, C2), a cell (R1, C3) and a cell (R2, C1). The intra-cell strokes (handwritten character string “ABC”) are written in the cells (R1, C1) and (R1, C2).

In this case, as indicated in the upper right portion of FIG. 13, in an L-shaped region in a digital table object corresponding to the L-shaped region 61, three cells arranged horizontally, i.e., cells (R1, C1), (R1, C2) and (R1, C3) are preferentially combined to form one merged cell. As a result, the L-shaped region of the digital table object comprises merged cell 71A and single cell 71B. Merged cell 71A is a rectangular merged cell obtained by combining the cells (R1, C1), (R1, C2) and (R1, C3). The regions 62 and 63 of the handwritten table are converted into cells 72 and 73 in the digital table object, respectively.

Since the handwritten character string “ABC” is written in the cells (R1, C1) and (R1, C2) of the handwritten table, the recognition result of the character string “ABC” is positioned in merged cell 71A obtained by combining the cells (R1, C1), (R1, C2) and (R1, C3). At this time, the recognition result of the handwritten character string “ABC” is centered within merged cell 71A and displayed in the middle of merged cell 71A.

If the two cells arranged vertically are combined to form one merged cell and the remaining two cells arranged horizontally are combined to form another merged cell, the handwritten character string “ABC” may be divided into two portions, as is shown in the lower right portion of FIG. 13.

Namely, since the handwritten character “A” is written in the cell (R1, C1) of the handwritten table, the recognition result of the handwritten character “A” is displayed in the middle of merged cell 71B obtained by combining the cells (R1, C1) and (R2, C1). Similarly, since the handwritten character string “BC” is written in the cell (R1, C2) of the handwritten table, the recognition result of the handwritten character string “BC” is displayed in the middle of merged cell 71A obtained by combining the cells (R1, C2) and (R1, C3). Thus, the handwritten character string “ABC” is divided into two portions.

In view of the above, in the embodiment, when the positions of the strokes in the L-shaped region of the handwritten table corresponds to some cells adjacent horizontally in a digital table object, at least the cells adjacent horizontally are preferentially combined to form one merged cell.

In FIG. 14, the handwritten table includes an L-shaped region (L-shaped merged cell) 61, and two rectangular regions (cells) 62 and 63. The L-shaped region (L-shaped merged cell) 61 includes cells (R1, C1), (R1, C2), (R1, C3) and (R2, C1). The intra-cell strokes (handwritten character string “ABC”) are written in the cells (R1, C1) and (R2, C1).

In this case, in the L-shaped region of the digital table object corresponding to the L-shaped region 61, the two cells arranged vertically are preferentially combined to form one merged cell, as is shown in the upper right portion of FIG. 14. Namely, the L-shaped region of the digital table object comprises merged cell 71A and merged cell 71B. Merged cell 71B is obtained by combining the cells (R1, C1) and (R2, C1). The remaining two cells in the L-shaped region of the digital table object are combined to form merged cell 71A. The regions 62 and 63 of the handwritten table are converted into cells 72 and 73 of the digital table object, respectively.

Since the handwritten character string “ABC” is written in the cells (R1, C1) and (R2, C1) of the handwritten table, the recognition result of the character string “ABC” is displayed in the middle of merged cell 71B obtained by combining the cells (R1, C1) and (R2, C1).

If the three cells arranged horizontally are combined to form one merged cell, the handwritten character string “ABC” may be divided into two portions, as is shown in the lower right portion of FIG. 14.

Namely, since the handwritten character “A” is written in the cell (R1, C1) of the handwritten table, the recognition result of the handwritten character “A” is displayed in the middle of merged cell 71A obtained by combining the cells (R1, C1), (R1, C2) and (R1, C3). Similarly, since the handwritten character string “BC” is written in the cell (R2, C1) of the handwritten table, the recognition result of the handwritten character string “BC” is displayed in the cell 71B formed of a single cell (R2, C1). Thus, the handwritten character string “ABC” is divided into two portions.

In view of the above, in the embodiment, when the positions of one or more strokes in the L-shaped region of the handwritten table correspond to some cells adjacent vertically in the digital table object, at least the cells adjacent vertically are preferentially combined to form one merged cell.

The recognition result display processing module 313 of FIG. 6 displays a digital table object corresponding to a handwritten table on the screen of the LCD 17A. To display the digital table object, the recognition result display processing module 313 may copy the digital table object on a clipboard. In this case, the digital table object may be copied on the clipboard as a digital table object (data file) having a data format which can be used by a spread sheet application.

Alternatively, the recognition result display processing module 313 may output (export) the digital table object to an office application, such as the spread sheet application, in order to display the digital table object. In this case, the digital table object may be exported as a digital table object (data file) having a data format which can be used by the spread sheet application.

All or part of the above-described functions associated with the table recognition by the processing module 305 may be executed by the server 2.

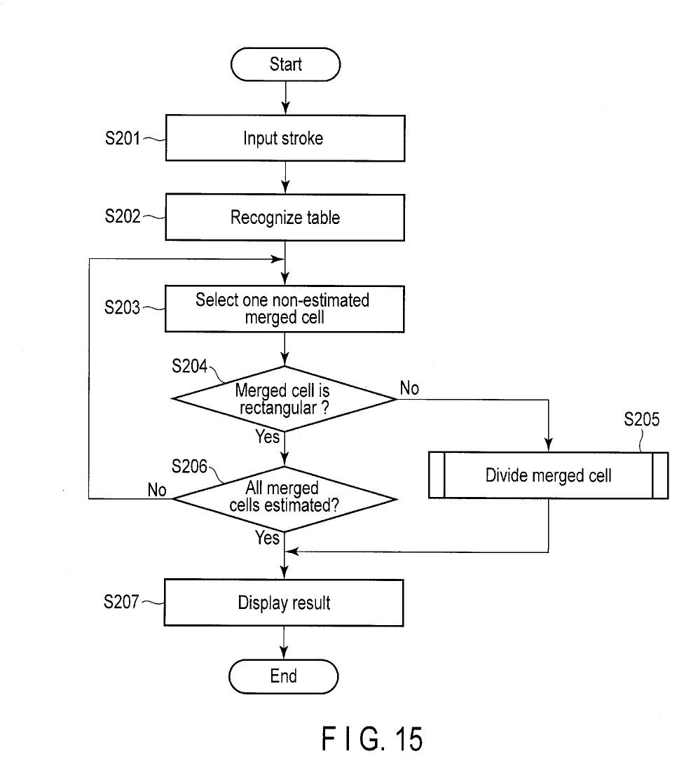

The flowchart of FIG. 15 shows a procedure of converting a handwritten table to a digital table object.

The CPU 101 performs the following processing by executing the handwritten note application program 202.

Firstly, the CPU 101 receives strokes input by handwriting from the touch screen display 17 (step S201). The CPU 101 cooperates with the graphics controller 104 to execute processing for displaying each stroke input by handwriting on the screen of the touch screen display 17. As a result, a handwritten document (handwritten page) including a plurality of strokes is displayed on the screen of the touch screen display 17. The input device for inputting strokes is not limited to the touch screen display 17. For instance, the input device for inputting strokes may be the camera 109. In this case, an image of strokes handwritten on a whiteboard or paper may be captured by the camera 109. The CPU 101 may execute processing for displaying the image of the strokes, captured by the camera 109, as a handwritten page on the screen of the touch screen display 17.

When the user has selected a function needed for handwritten page recognition, such as a function “copy as office data” or “export,” the CPU 101 executes table recognition processing of recognizing a handwritten table within the handwritten page (step S202). In table recognition processing, the CPU 101 detects a set of strokes (ruled-line strokes) corresponding to vertical and horizontal ruled lines in the handwritten document (page). Based on the detected set of strokes (ruled-line strokes) corresponding to the vertical and horizontal ruled lines, the CPU 101 recognizes the structure of the handwritten table. Subsequently, the CPU 101 converts the handwritten table into a digital table object that includes the same number of regions (cells) as the regions (cells) in the handwritten table. Each region (cell) in the digital table object may be formed of a single (unit) cell or a merged cell. The CPU 101 recognizes, as a single (unit) cell, a region (cell) that does not span a plurality of adjacent columns or rows within the handwritten table, and converts, into a single cell within the digital table object, the region (cell) that does not span a plurality of adjacent columns or rows within the handwritten table. Further, the CPU 101 recognizes, as a merged cell, a region (cell) that spans at least a plurality of adjacent columns or rows within the handwritten table, and converts, into a merged cell within the digital table object, the region (cell) that spans at least a plurality of adjacent columns or rows within the handwritten table.

In table recognition processing, the CPU 101 may recognize strokes in each cell using character recognition processing. In this case, a handwritten character string in each cell of the handwritten table is converted into text (character code). The text (character code) is inserted in a corresponding cell in the digital table object.

To detect a non-rectangular region (non-rectangular merged cell) in the digital table object, the CPU 101 estimates each merged cell in the digital table object (table recognition result). Firstly, the CPU 101 selects a merged cell from non-estimated merged cells (step S203). The CPU 101 determines whether the selected merged cell is rectangular or non-rectangular (step S204).

If the shape of the selected merged cell corresponds to a rectangular shape (Yes in step S204), the CPU 101 determines whether all merged cells have been estimated (step S206). If a non-estimated merged cell exists (No in step S206), the CPU 101 re-executes step S203 et seq.

If the shape of the selected merged cell corresponds to a non-rectangular shape (No in step S204), the CPU 101 executes merged cell diving processing of dividing the selected merged cell into a plurality of cells (divided cells) each having a rectangular shape (step S205). In merged cell dividing processing, the selected merged cell is basically divided into two or more merged cells each having a rectangular shape. However, depending upon the shape of the selected merged cell, the merged cell may be divided to form a combination of one or more rectangular merged cells and one or more unit cells. In any case, at least one of “the plurality of divided cells” is a rectangular merged cell. After that, the CPU 101 determines whether all merged cells have been estimated (step S206). If any non-estimated merged cell exists (No in step S206), the CPU 101 re-executes step S203 et seq.

If it is determined that all merged cells have been estimated (Yes in step S206), the CPU 101 cooperates with the graphics controller 104 to display the result of recognition (i.e., a digital table object obtained after merged cell dividing processing) on the screen of the touch screen display 17 (step S207). In step S207, the CPU 101 may output a digital table object to an office application, such as the spread sheet application. In this case, the CPU 101 may copy the digital table object on the clipboard. Alternatively, the CPU 101 may directly output (export) the digital table object to an office application, such as the spread sheet application. Since the digital table object does not include a non-rectangular merged cell (e.g., an L-shaped merged cell), an office application, such as the spread sheet application, can normally display the digital table object.

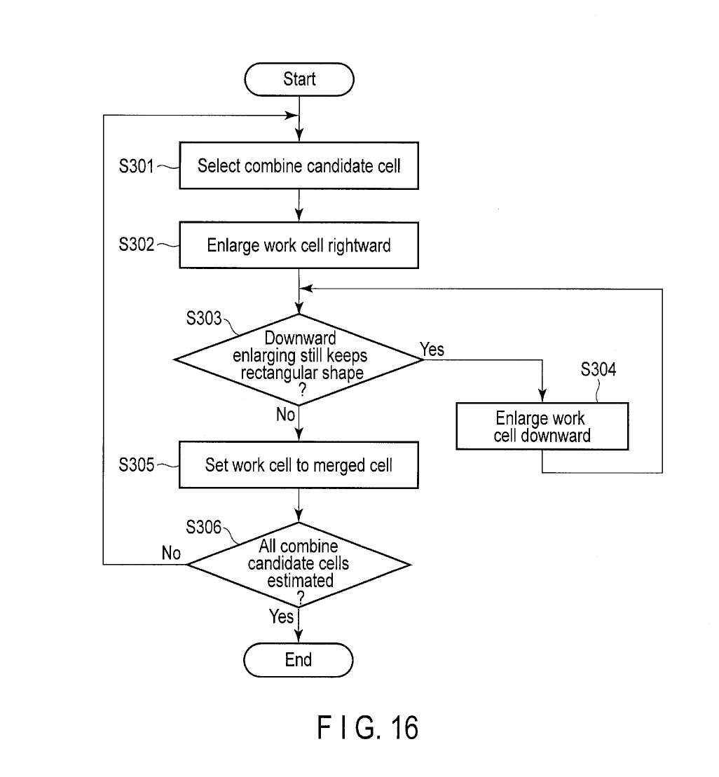

The flowchart of FIG. 16 shows a procedure of merged cell dividing processing.

In the description below, each unit cell in a non-rectangular region (non-rectangular merged cell) in the digital table object will be referred to as a combine candidate cell. The CPU 101 estimates all combine candidate cells in order to divide a non-rectangular merged cell into some rectangular cells (more specifically, into some rectangular merged cells, or into a combination of some rectangular merged cells and some unit cells).

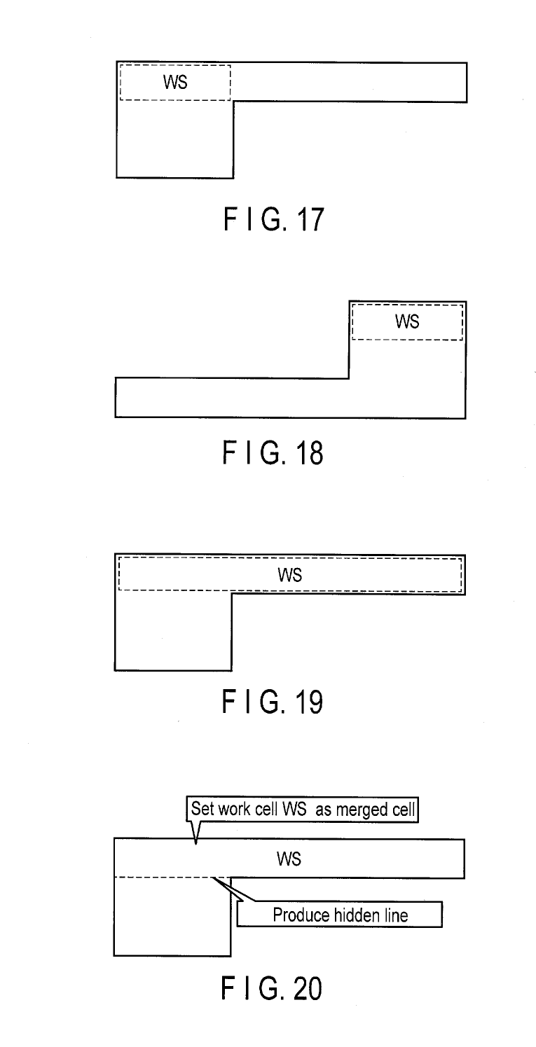

Firstly, the CPU 101 selects an upper left combine candidate cell (an uppermost left combine candidate cell) as a work cell from non-estimated combine candidate cells (step S301). If the upper left combine candidate cell and the uppermost combine candidate cell are unit cells different from each other, the uppermost combine candidate cell may be selected preferentially. If a non-rectangular merged cell has a shape as shown in FIG. 17, the upper left combine candidate cell (uppermost left combine candidate cell) is selected as a work cell (WS) as shown in FIG. 17. In contrast, if a non-rectangular merged cell has a shape as shown in FIG. 18, the uppermost combine candidate cell is selected as a work cell (WS) as shown in FIG. 18.

The CPU 101 rightward enlarges the work cell within the range of the combine candidate cells (step S302). In step S302, the work cell can be enlarged as much as possible as shown in FIG. 19.

The CPU 101 downward enlarges the work cell within the range of the combine candidate cells. In this case, firstly, the CPU 101 determines whether the work cell can be enlarged downward, with the shape of the work cell kept rectangular (step S303).

If the work cell can be enlarged downward, with the shape of the work cell kept rectangular (Yes in step S303), the CPU 101 downward enlarges the work cell (step S304).

In contrast, if the work cell cannot be enlarged downward, with the shape of the work cell kept rectangular (No in step S303), the CPU 101 creates a merged cell by combining all unit cells in the current work cell range, and creates a hidden ruled line between the merged cell and other combine candidate cells adjacent to the merged cell (step S305). As a result, the current work cell (WS) becomes an independent merged cell as shown in FIG. 20. Thus, the hidden ruled line is set between the merged cell and the other combine candidate cells.

The CPU 101 determines whether all combine candidate cells have been estimated (step S306). If any non-estimated combine candidate cell exists (No in step S306), the CPU 101 re-executes step S301 et seq.

Although in the embodiment, the uppermost combine candidate cell is selected preferentially when the upper left combine candidate cell and the uppermost combine candidate cell are different unit cells, the upper left combine candidate cell may be selected preferentially. Further, although in the embodiment, the range of the work cell is enlarged rightward in preference to downward, it may be enlarged downward in preference to rightward. Yet alternatively, the direction in which the range of the work cell is preferentially enlarged may be determined in accordance with the position of a handwritten character string.

By the above-described merged cell dividing processing, a non-rectangular region (non-rectangular merged cell) in the digital table object can be divided into a plurality of merged cells each having a rectangular shape. Furthermore, by setting, as a hidden ruled line, a ruled line newly created when a non-rectangular merged cell is divided, a plurality of merged cells each having a rectangular shape can be displayed as if they provide a non-rectangular merged cell similar to a non-rectangular cell in a handwritten table.

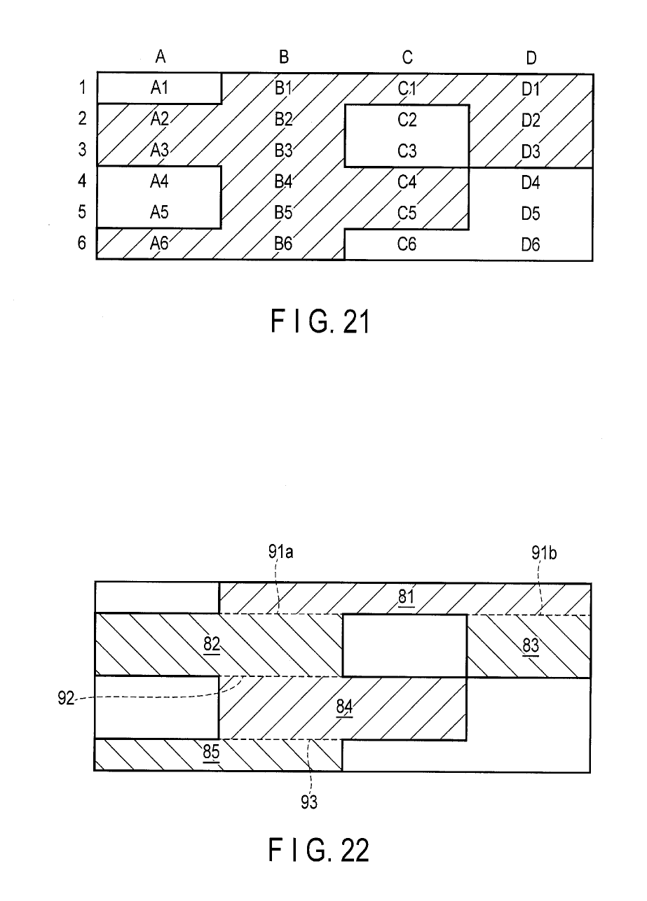

Referring then to FIGS. 21 and 22, a description will be given of an example of merged cell dividing processing performed on a non-rectangular region in a digital table object. FIG. 21 shows an example of a digital table object as a recognition result of a handwritten table, and FIG. 22 shows a merged cell dividing processing result. It should be noted that symbols and numbers A to D, 1 to 6 and A1 to D6 in FIG. 21 and the hatching in FIGS. 21 and 22 are merely used for explanation, and are not actually displayed.

In step S301, cell B1 is selected as a work cell. In step S302, the work cell is enlarged rightward. Cells C1 and D1 are added to the work cell, whereby the work cell includes cells B1, C1 and D1.

In step S303, the work cell is attempted to be downward enlarged. However, since cell C2 is not a combine candidate cell, if the work cell is downward enlarged, it cannot be kept rectangular. Therefore, the program proceeds to step S305.

In step S305, the current work cell (cells B1, C1 and D1) is set as a merged cell. Hidden ruled lines (denoted by reference numbers 91a and 91b in FIG. 22) are provided between the merged cell and combine candidate cells adjacent thereto (in this example, between cells B1 and B2 and between cells D1 and D2), whereby the merged cell and the combine candidate cells adjacent thereto are divided from each other. As a result, a merged cell 81 shown in FIG. 22 is obtained. The combine candidate cells other than those belonging to the merged cell 81 are not yet estimated.

In step S306, it is determined that there is a not yet estimated combine candidate cell, and hence the program returns to step S301.

In step S301, cell A2 is selected as a work cell. In step S302, the work cell is enlarged rightward, whereby the work cell includes cells A2 and B2.

In step S303, it is determined that even if the work cell is enlarged downward, it is kept rectangular, and therefore the program proceeds to step S304.

In step S304, the work cell is enlarged to a range that includes cells A2, B2, A3 and B3, and the program returns to step S303.

In step S303, it is determined that the work cell cannot be kept rectangular if it is downward enlarged, and hence the program proceeds to step S305.

In step S305, the current work cell (cells A2, B2, A3 and B3) is set as a merged cell. A hidden ruled line (denoted by reference number 92 in FIG. 22) is provided between the merged cell and a combine candidate cell adjacent thereto (in this example, between cells B3 and B4), whereby the merged cell and the combine candidate cell adjacent thereto are divided from each other. As a result, a merged cell 82 shown in FIG. 22 is obtained. The combine candidate cells other than those belonging to the merged cells 81 and 82 in FIG. 22 are not yet estimated.

In step S306, it is determined that a not yet estimated combine candidate cell exists, whereby the program returns to step S301.

Similarly, merged cells 83, 84 and 85 shown in FIG. 22 are produced. The merged cell 83 is produced by combining two unit cells D2 and D3. The merged cell 84 is produced by combining four unit cells B4, C4, B5 and C5. The merged cell 85 is produced by combining two unit cells A6 and B6. In step S306, it is determined that all combine candidate cells have been estimated, and hence the process is finished. A hidden ruled line 93 is provided between the merged cells 84 and 85.

In the embodiment, the hatched area is divided into five rectangular merged cells 81, 82, 83, 84 and 85 as shown in FIG. 21. If the hatched area of FIG. 21 does not include cell A6, it is divided to form a combination of four merged cells 81, 82, 83 and 84 and single cell B6.

As described above, in the embodiment, if a handwritten table (i.e., plural regions in the handwritten table) includes a first region that spans columns or rows, and whose shape corresponds to a rectangular shape, the result of recognition of the handwritten table is a first table object that includes a first merged cell corresponding to the first region of the plural regions and a plurality of cells corresponding to other regions of the plural regions.

In contrast, if the shape of the first region corresponds to a non-rectangular shape, such as an L shape, the recognition result of the handwritten table is a second table object that includes a second merged cell corresponding to a part of the first region of the plural regions and the plurality of cells corresponding to other regions of the plural regions, the second merged cell having a rectangular shape.

The second table object may also include a third merged cell corresponding to the remaining part of the first region, the second merged cell having a rectangular shape.

For example, a non-rectangular region in the second table object, which corresponds to the first region, may be formed of a combination of two or more merged cells each having a rectangular shape, or a combination of one or more merged cells each having a rectangular shape and one or more unit cells.

Therefore, a table object (digital table object) similar in structure to the handwritten table including a region (merged cell) that spans at least a plurality of columns or rows can be output. Further, even when the handwritten table includes an L-shaped region (L-shaped merged cell), a table object (digital table object) that does not include an L-shaped merged cell can be output. Accordingly, the recognition result (digital table object) of the handwritten table can be used by various application programs.

Yet further, a set of cells, which are included in the cells of a non-rectangular region in the digital table object, and should be combined to form one merged cell, are determined in accordance with the positions of strokes written in the non-rectangular region of the handwritten table. This can avoid a disadvantage that a handwritten character string in the non-rectangular region of the handwritten table is divided and placed in separate portions of the digital table object.

Each of the functions described in the embodiment may be realized by processing circuitry. The processing circuitry includes, for example, a programmed processor, such as a central processing unit (CPU). This processor executes the described functions by executing a computer program (a group of commands) stored in a memory. The processor may be a microprocessor including electric circuits. The processing circuitry may also include a digital signal processor (DSP), an application specific integrated circuit (ASIC), a microcontroller, a controller and other electric circuit components. Each of the components other than the CPU employed in the embodiment may be realized by the processing circuitry.

Further, since various types of processing in the embodiment can be realized by a computer program, an advantage similar to that of the embodiment can be obtained simply by installing the computer program in a computer through a computer-readable storage medium storing the computer program, and executing the program.

In addition, although the embodiment is directed to the case of Using a tablet computer, each function employed in the embodiment is also applicable to a standard desktop personal computer. In this case, it is sufficient if a tablet, for example, as an input device for handwriting input is connected to the desktop personal computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
display controller configured to display on a screen a handwritten document comprising a handwritten table, the handwritten table comprising a plurality of regions defined by a set of strokes corresponding to horizontal and vertical ruled lines; and
processing circuitry configured to execute a process for outputting a recognition result of the handwritten table,
wherein when a first region of the plurality of regions spans columns or rows, and the first region corresponds to a rectangular shape, the recognition result of the handwritten table comprises a first table object, wherein the first table object comprises a first merged cell corresponding to the first region of the plurality of regions and a plurality of cells corresponding to other regions of the plurality of regions, and
wherein when the first region of the plurality of regions spans columns or rows, and the first region corresponds to a non-rectangular shape, the recognition result of the handwritten table comprises a second table object, wherein the second table object comprises a second merged cell corresponding to a part of the first region of the plurality of regions and the plurality of cells corresponding to other regions of the plurality of regions, the second merged cell having a rectangular shape.

2. The electronic device of claim 1, wherein the second table object further comprises a third merged cell corresponding to a remaining part of the first region, the third merged cell having a rectangular shape, and
wherein a hidden ruled line is set in a boundary between the second merged cell and the third merged cell.

3. The electronic device of claim 1, wherein a set of cells to be combined into the second merged cell is determined in accordance with positions of one or more strokes written in the first region.

4. The electronic device of claim 1, wherein
a region of the second table object corresponding to the first region comprises at least a first cell and a second cell aligned horizontally, and a third cell aligned vertically with the first cell,
when positions of one or more strokes written in the first region corresponding to the first and the second cell of the second table object, at least the first and the second cell are combined into the second merged cell, and
when the positions of one or more strokes written in the first region corresponding to the first and the third cell of the second table object, at least the first and the third cell are combined into the second merged cell.

5. The electronic device of claim 1, wherein each of the first and second table objects comprises a data file capable of being processed by a spread sheet application program.

6. A method comprising:
displaying on a screen a handwritten document comprising a handwritten table, the handwritten table comprising a plurality of regions defined by a set of strokes corresponding to horizontal and vertical ruled lines; and
executing a process for outputting a recognition result of the handwritten table,
wherein when a first region of the plurality of regions spans columns or rows, and the first region corresponds to a rectangular shape, the recognition result of the handwritten table comprises a first table object, wherein the first table object comprises a first merged cell corresponding to the first region of the plurality of regions and a plurality of cells corresponding to other regions of the plurality of regions, and
wherein when the first region of the plurality of regions spans columns or rows, and the first region corresponds to a non-rectangular shape, the recognition result of the handwritten table comprises a second table object, wherein the second table object comprises a second merged cell corresponding to a part of the first region of the plurality of regions and the plurality of cells corresponding to other regions of the plurality of regions, the second merged cell having a rectangular shape.

7. The method of claim 6, wherein the second table object further comprises a third merged cell corresponding to a remaining part of the first region, the third merged cell having a rectangular shape, and
wherein a hidden ruled line is set in a boundary between the second merged cell and the third merged cell.

8. The method of claim 6, wherein a set of cells to be combined into the second merged cell is determined in accordance with positions of one or more strokes written in the first region.

9. The method of claim 6, wherein
a region of the second table object corresponding to the first region comprises at least a first cell and a second cell aligned horizontally, and a third cell aligned vertically with the first cell,
when positions of one or more strokes written in the first region corresponding to the first and the second cell of the second table object, at least the first and the second cell are combined into the second merged cell, and
when the positions of one or more strokes written in the first region corresponding to the first and the third cell of the second table object, at least the first and the third cell are combined into the second merged cell.

10. The method of claim 6, wherein each of the first and second table objects comprises a data file capable of being processed by a spread sheet application program.

11. A computer-readable, non-transitory storage medium having stored a computer program which is executable by a computer, the computer program controlling the computer to execute functions of:
displaying on a screen a handwritten document comprising a handwritten table, the handwritten table comprising a plurality of regions defined by a set of strokes corresponding to horizontal and vertical ruled lines; and
executing a process for outputting a recognition result of the handwritten table,
wherein when a first region of the plurality of regions spans columns or rows, and the first region corresponds to a rectangular shape, the recognition result of the handwritten table comprises a first table object, wherein the first table object comprises a first merged cell corresponding to the first region of the plurality of regions and a plurality of cells corresponding to other regions of the plurality of regions, and
wherein when the first region of the plurality of regions spans columns or rows, and the first region corresponds to a non-rectangular shape, the recognition result of the handwritten table comprises a second table object, wherein the second table object comprises a second merged cell corresponding to a part of the first region of the plurality of regions and the plurality of cells corresponding to other regions of the plurality of regions, the second merged cell having a rectangular shape.

12. The storage medium of claim 11, wherein the second table object further comprises a third merged cell corresponding to a remaining part of the first region, the third merged cell having a rectangular shape, and
wherein a hidden ruled line is set in a boundary between the second merged cell and the third merged cell.

13. The storage medium of claim 11, wherein a set of cells to be combined into the second merged cell is determined in accordance with positions of one or more strokes written in the first region.

14. The storage medium of claim 11, wherein
a region of the second table object corresponding to the first region comprises at least a first cell and a second cell aligned horizontally, and a third cell aligned vertically with the first cell,
when positions of one or more strokes written in the first region corresponding to the first and the second cell of the second table object, at least the first and the second cell are combined into the second merged cell, and
when the positions of one or more strokes written in the first region corresponding to the first and the third cell of the second table object, at least the first and the third cell are combined into the second merged cell.

15. The storage medium of claim 11, wherein each of the first and second table objects comprises a data file capable of being processed by a spread sheet application program.
